(19) United States
(12) Patent Application Publication
(10) Pub. No.: US 2010/0109576 A1
(43) Pub. Date: May 6, 2010

(54) GENERAL ILLUMINATION SYSTEM AND AN ILLUMINAIRE

(75) Inventors: Willem Lubertus Ijzerman, Eindhoven (NL); Gabriel-Eugen Onac, Eindhoven (NL); Johanna Cornelis Maria Francisca Tielens-Aarts, Eindhoven (NL); James Joseph Anthony Mccormack, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/532,437

(22) PCT Filed: Mar. 27, 2008
(86) PCT No.: PCT/IB08/51145

§ 371 Date: Sep. 22, 2009

(30) Foreign Application Priority Data
Mar. 29, 2007 (EP) 07105169.2

(51) Int. Cl. H05B 39/00; F21V 1/00

(52) U.S. Cl. 315/312; 362/235

(57) ABSTRACT

A lighting system is presented. The lighting system comprises a light guide (3), a lighting source (5) arranged for coupling light into the light guide (3), wherein the light guide (3) is arranged such that at least part of the light is emitted in a first general direction (21, 121), and at least part of the light is emitted in a second general direction (23, 123) different to the first direction (21, 121).

### TECHNICAL FIELD

The present invention relates to a lighting system, and an illuminaire.

### BACKGROUND ART

Light emitting diode (LED) technology develops rapidly. The increasing amount of lumen per LED package together with the decreasing amount of money per lumen may in the future introduce LED technology on a large scale to the general lighting market.

Commercial departments may use the looks of an illumination system in order to distinguish themselves from their competitors. Therefore, there is a need for a generic lighting system that can be customized after installation. It is also desirable that the system can be changed easily, such that a new system or illumination pattern may be created in e.g. the ceiling at low cost. This may be desirable due to season changes, discount offers etc.

Therefore, it is a problem to design such illuminaire.

### SUMMARY OF THE INVENTION

It is an object of the present invention to provide a lighting system having increased functionality.

Hence, a lighting system is provided comprising a light guide, a light source arranged for coupling light into the light guide,

wherein the light guide is arranged such that at least part of the light is emitted in a first general direction, and

at least part of the light is emitted in a second general direction different to the first direction.

The inventive lighting system is advantageous in that it simultaneously may provide a general illumination and an illumination of e.g. an object.

The light coupled out from the light guide in the first general direction may be collimated, which is advantageous in that glare is avoided or reduced.

The light coupled out from the light guide in the second general direction may be divergent, which is advantageous in that e.g. an object may be illuminated uniformly.

The light guide may be a light guide plate.

The second general direction may be opposite to the first direction.

The light source may be a solid state light source. The solid state light source may be a light emitting diode.

The lighting system may comprise a plurality of light sources arranged for coupling light into the light guide. The plurality of light sources may be arranged in a distribution in a plane at the light guide. At least one section of the light source distribution may comprise an incoupling facet for coupling light from any light source into the light guide and a first outcoupling facet for coupling light out of the light guide in the first general direction, which is advantageous in that no external components are used for incoupling of light and outcoupling of light in the first general direction. At least one light source of said plurality of light sources may comprise a collimator, which is advantageous in that annoying glare is avoided or reduced in a simple way.

The section of the LED distribution further comprises a second outcoupling facet arranged for coupling light out of the light guide in the second general direction the section of the LED distribution further comprises a second outcoupling facet arranged for coupling light out of the light guide in the second general direction.

The section of the light source distribution may further comprise a second outcoupling facet arranged for coupling light out of the light guide in the second general direction, which is advantageous in that no external components are used for outcoupling of light in the second general direction.

Each first outcoupling facet may be opposite to corresponding incoupling facet, which is advantageously in that the fabrication is made easily.

The first or second, or both of the outcoupling facets may be reflective and tilted in relation to the plane of the light guide, which is advantageous in that less or no light from a LED will penetrate into another section, which would degrade light efficiency due to absorption or scattering at other light sources.

The second outcoupling facet may be curved, which is advantageous in that the extracted light may have a wider angular spread. This may also be accomplished by an outcoupling facet comprising a rough and diffusive reflecting surface.

The second outcoupling facet may be adjacent to the first outcoupling facet, which is advantageous in that the first and the second outcoupling facets may be manufactured in a simple way.

The first outcoupling facet and the second outcoupling facet may form a common v-shape, which is advantageous in that it is easy to adjust the amount of light extracted in the two different directions.

The second outcoupling facet may be arranged adjacent to the LED, which is advantageous where unmixed light is to be extracted in the second direction.

At least one LED of said plurality of LEDs may comprise a collimator and the collimator may comprise the second outcoupling facet, which is advantageous in that it makes use of less components.

The lighting system may further comprise an electronic control unit arranged to individually control at least one of the LEDs, which is advantageous in that a light pattern may be created.

According to another aspect of the invention, a transparent illuminaire may comprise a lighting system according to the invention. This is advantageous in that a discreet, elegant, stylish or attractive lamp may be created. For example, the lamp can be transparent such that a viewer can see the ceiling, where for example an image or a neat stucco work is present, through the lamp.

Generally, all terms used in the claims are to be interpreted according to their ordinary meaning in the technical field, unless explicitly defined otherwise herein. All references to “divergent” are to be interpreted openly as referring to a state of light where the incorporated light beams are spread from each other in the direction of travel. Compared to collimated light, the term “divergent light” means light having a broader angular distribution.

### BRIEF DESCRIPTION OF THE DRAWINGS

Embodiments of the present invention will now be described, by way of example, with reference to the accompanying schematic drawings, in which

FIG. 1 is a top view according to an embodiment of the present invention,

FIG. 2 is a top view according to a second embodiment of the present invention,

FIG. 3 is a side view of a section of the lighting system according to a third embodiment,

FIG. 4 is a side view of a section of the lighting system according to a fourth embodiment,

FIG. 5 is a side view of a section of the lighting system according to a fifth embodiment,

FIG. 6 is a side view of a section of the lighting system according to a sixth embodiment,

FIG. 7 is a side view of an alternative geometry for an illuminaire using LEDs, FIG. 8 is a side view of a second alternative geometry for an illuminaire using LEDs, and

FIG. 9 is a side view of a lighting system of the present invention in use.

### DETAILED DESCRIPTION OF PREFERRED EMBODIMENTS OF THE INVENTION

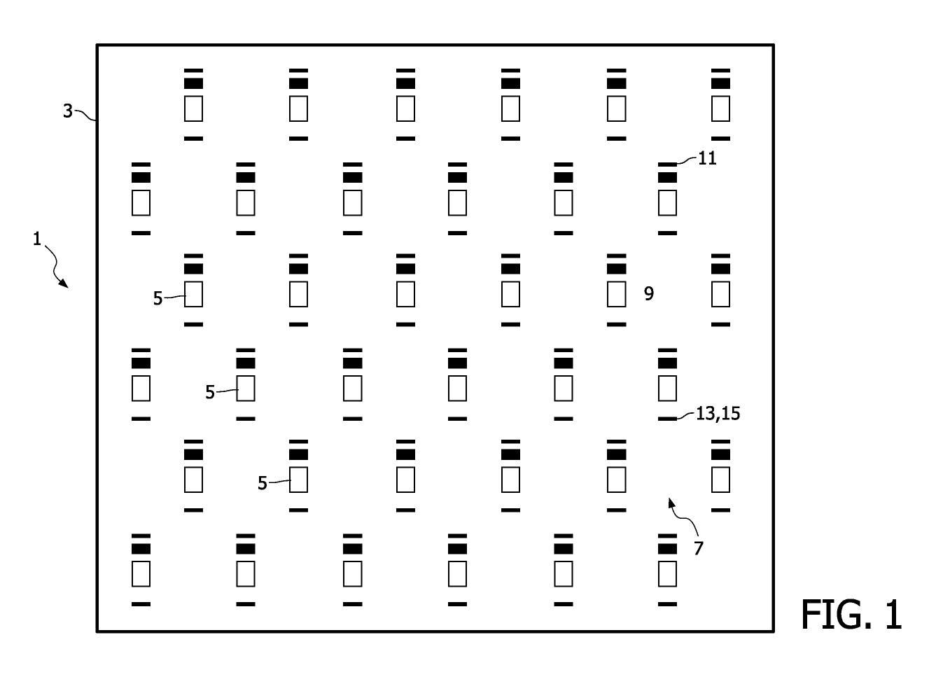

FIG. 1 illustrates a first embodiment of the present invention. A lighting system 1 comprises a light guide plate 3 and a plurality of light sources 5, in this exemplary embodiment light emitting diodes (LEDs), arranged in a staggered distribution 7. The LED distribution has a plurality of sections 9 and each such section 9 comprises an incoupling facet 11, a first outcoupling facet 13 and a second outcoupling facet 15.

It is to be noted that other light sources, which may be fluorescent or incandescent lamp, or a solid state light source, such as the exemplary LED or a solid state laser, can be used in any of the embodiments. Slight modifications may be necessary. For example, if a laser is used, no collimation is needed.

It is further to be noted that the number of light sources can be any from one to a large plurality, depending on how the lighting system is to be designed and used.

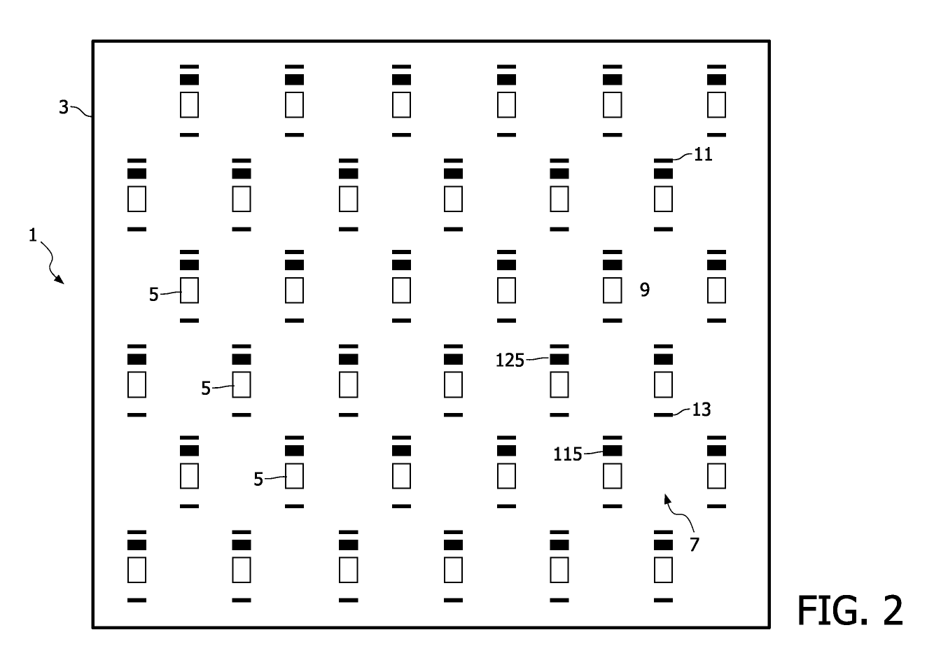

FIG. 2 illustrates a second embodiment of the present invention, where a lighting system 1 comprises a light guide plate 3 and a plurality of LEDs 5, arranged in a staggered distribution 7. The LED distribution has a plurality of sections 9 and each such section 9 comprises an incoupling facet 11, a first outcoupling facet 13 and a second outcoupling facet 115 arranged on a collimator 125.

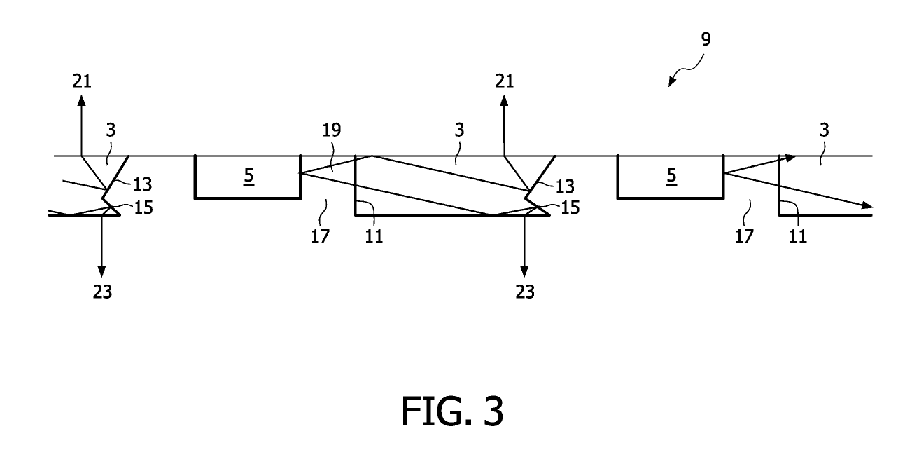

In FIG. 3 a section 9 according to an embodiment of the present invention is described in more detail. The LED 5 is positioned in a portion 17 of the light guide plate 3. The portion 17 may for example be an excess, a hole or a portion comprising a different light guide material. The LED 5 may also be moulded or mounted in any other suitable way into the light guide plate 3. The LED 5 emits light in a general light emitting direction 19 and with an angular distribution that depends on the used LED. Thus, the emitted light may form a beam profile of any type common for LED technology. The LED 5 may be a side emitting LED or a top emitting LED tilted about 90 degrees. The general light emitting direction 19 is towards the incoupling facet 11. The incoupling facet 11 is arranged perpendicular to the plane of the light guide plate 3, therefore the incident light is not reflected when it transmits into the light guide plate 3.

The first outcoupling facet 13 is positioned opposite to the incoupling facet 11, i.e. the light emitted from the LED 5 in the light emitting direction 19 will not be incident on the first outcoupling facet 13. The first outcoupling facet 13 is arranged inclined to the plane of the light guide plate 3. The second outcoupling facet 15 is positioned adjacent to the first outcoupling facet 13 such that the first and the second outcoupling facet 13 and 15 forms a V-shape. The level of inclination of the first and the second outcoupling facet 13 and 15 is set as design parameters, as well as the physical proportions of the first and second outcoupling facet 13 and 15.

The light emitted from the LED 5 in the light emitting direction 19 is incident on the incoupling facet 11. The light is transmitted into the light guide plate 3 and propagates in said light guide plate 3 under total internal reflection (TIR). The beam profile of the LED 5 may be collimated. Due to the TIR condition, light from several LEDs 5 is mixed in the light guide plate 3.

After the light has propagated in said light guide plate 3, a first part of the light will be incident on a first outcoupling facet 13. Since the first outcoupling facet 13 is slanted, the TIR condition will not be valid any longer, and the first part of the light will be reflected and extracted from the light guide plate 3 in a first general direction 21. The reflection of the light may be further enhanced by making the first outcoupling facet 13 in a light reflecting material, such as a metal.

A second part of the light which is propagating in the light guide plate 3 will be incident on the second outcoupling facet 15. Since the second outcoupling facet 15 is slanted in a direction opposite to the first outcoupling facet 13, the TIR condition will not be valid and the second part of the light will be reflected and extracted from the light guide plate 3 in a second general direction 23 opposite to the first general direction 21. The amount of light extracted in the different directions 21 and 23 may be adjusted by individually changing the lengths of the V-shape formed by the first and second outcoupling facets 13 and 15. If an equal amount of light in both directions 21 and 23 is desirable, for example, the first and second outcoupling facets 13 and 15 should be equally arranged components, i.e. they should form a symmetrical V-shape.

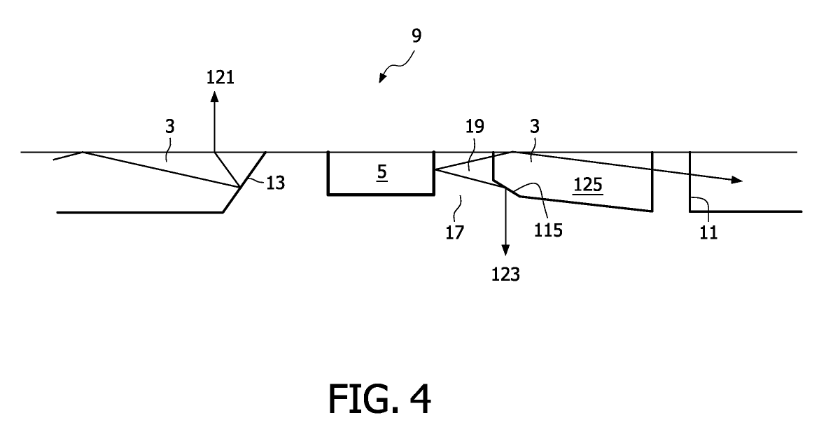

FIG. 4 illustrates a second embodiment where a section 9 comprises a light guide plate 3 and a portion 17. The portion 17 comprises a LED 5 and a collimator 125. The collimator 125 is positioned between the LED 5 and the incoupling facet 11. Alternatively, the collimator can be a part of the light guide, e.g. being integrated in the light guide plate. In this alternative embodiment, there is no incoupling facet. Returning to the embodiment illustrated in FIG. 4, opposite to said incoupling facet 11, a first outcoupling facet 13 is arranged at the interface between the portion 17 and the light guide plate 3. The collimator 125 comprises a second outcoupling facet 115, facing the LED 5.

The light emitted from the LED 5 has a direction 19, and the light is incident on the collimator 125. A first part of the light is incident on the planar surface of the collimator 125, collimated by said collimator 125 and emitted out from the collimator 125 and thereby incident on the incoupling facet 11. When the first part of the light enters the light guide plate 3, it will travel under substantially total internal reflection in the light guide plate 3 and mix with light emitted from other LEDs 5 present in the lighting system 1 until it is incident on a first outcoupling facet 13. The first part of the light may then be extracted from the light guide plate 3 in a first general direction 121. A second part of the light emitted from the LED 5 will however be incident on the slanted surface of the collimator, i.e. the second outcoupling facet 115. The second part of the light will then be reflected and extracted out from said portion 17 in a second general direction 123 opposite to said first general direction 121. The second part of the light is then unmixed, which means that each LED 5 will extract collimated and mixed light in the first general direction 121, and divergent and unmixed light in the second direction 123.

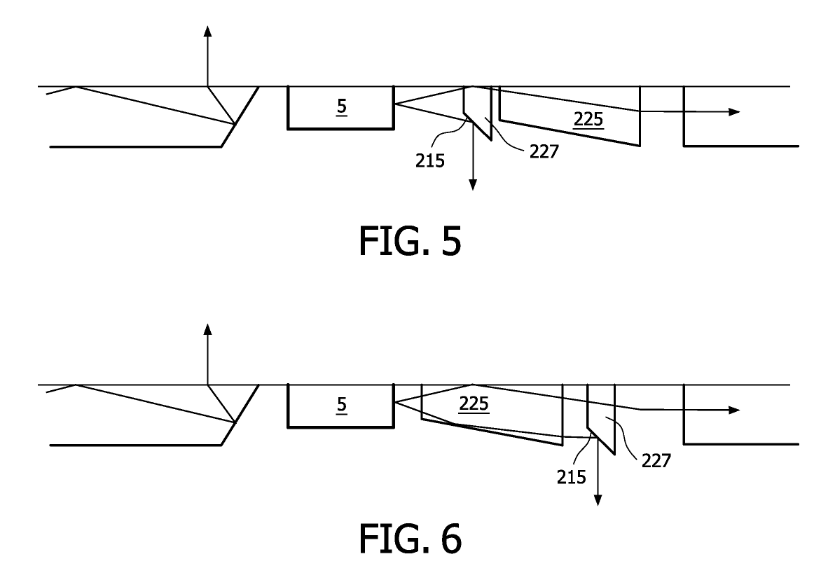

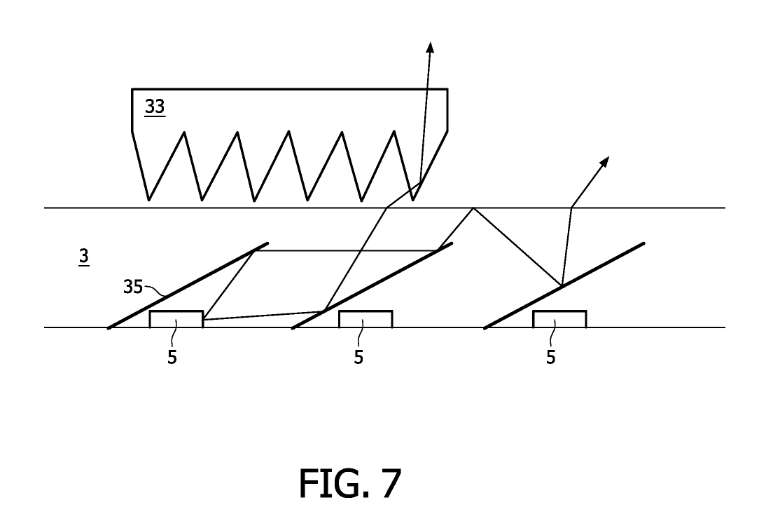

FIGS. 5 and 6 illustrates alternative embodiments of the portion 17. In FIG. 5, an optical component 227 is arranged between the LED 5 and the collimator 225. The optical component 227 comprises an outcoupling facet 215. In FIG. 6 the optical component 227 is arranged between the collimator 225 and the incoupling facet 11.

Although specific embodiments of the present invention have been described above, different geometries or designs for incoupling and mixing of light can be applicable for the present invention.

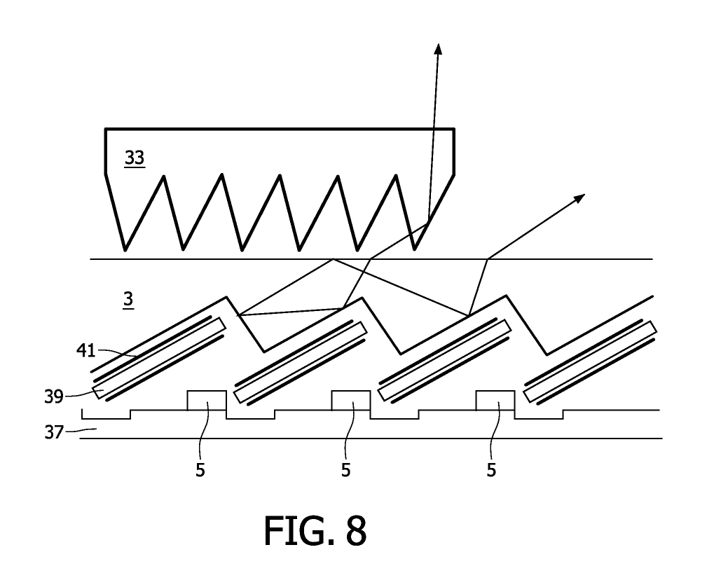

FIGS. 7 and 8 illustrates alternative geometries for luminaries using LEDs and a light guide for mixing the light. In FIG. 7, a light guide plate 3 is shown having a plurality of LEDs 5 arranged in the plane of the light guide 3. Adjacent to each LED 5, a mirror strip 35 is arranged for incoupling of light into the light guide plate 3. An asymmetric redirection foil 33 is arranged adjacent to the light guide plate 3 for changing the direction of the light outcoupled from the light guide plate 3.

In FIG. 8, another illuminaire geometry is shown. A plurality of LEDs 5 are arranged on a printed circuit board 37 that also comprises a plurality of slots. A light guide plate 3 comprises mini wedges, and the light guide plate 3 is arranged such that the plurality of LEDs 5 are arranged in a plane at the light guide plate 3. Collimator strips 39 are arranged adjacent to the LEDs 5 for incoupling of light into said light guide 3. Each collimator strip 39 comprises surrounding mirror strips 41. An asymmetric redirection foil 33 is arranged adjacent to the light guide plate 3 for changing the direction of the light outcoupled from the light guide plate 3.

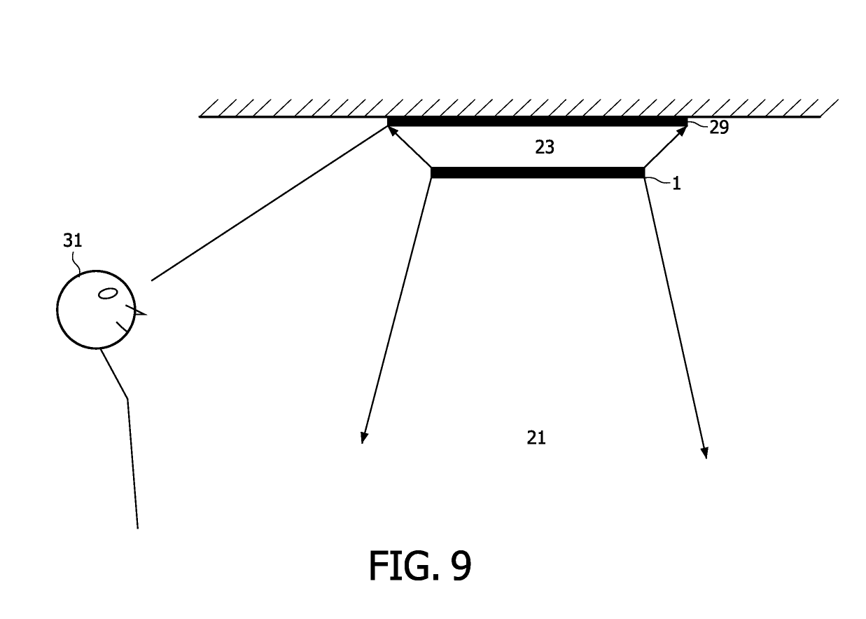

FIG. 9 illustrates an embodiment of a lighting system 1, attached to a ceiling but similar applies, which can be readily understood, for any mounting, such as of a wall etc. The lighting system 1 emits collimated light in a first general direction 21 towards the floor thus creating a general illumination, and light in a second direction 23. The light emitted in the second direction 23 may be collimated or non-collimated, i.e. divergent. An object 29 can be attached to the ceiling above the lighting system 1, such that the object 29 is illuminated by the light emitted from the lighting system 1 in the second direction 23. Due to the different degree of collimation of the light emitted in the first direction 21 and the light emitted in the second direction 23, a spectator 31 watching the illuminated object 29 will not be glared by the general illumination.

Now referring to FIGS. 4, 5, 6, and 9, in a further embodiment, each LED 5 arranged in the distribution 7 may be controlled individually by a control unit. The LEDs 5 may emit light in different colors, and since mixed light is extracted in the first general direction 21, 121 the general illumination will be of homogenous color. However, the light which is extracted in the second direction 23, 123 is divergent and unmixed, and will create a bright spot on the ceiling. Since the LEDs 5 can be individually controlled, a static or dynamic picture can be created on the ceiling. The light emitted in the second general direction 23, 123 may also be collimated in order to achieve a more distinct light spot from each LED 5. The distance between the lighting device 1 and the ceiling determines the size of the spot, and typically this distance may be about the same distance between two LEDs. For such application, the resolution may be approximately one LED per cm². By using low power LEDs, in the order of 60 mW, the overall power consumption of the lighting system 1 is lowered and the need for a heat management system such as a heat sink is eliminated. It should be noted that improvements in LED efficiency, and/or the use of higher power LEDs, will allow for larger LED spacing, while keeping the light output of the lighting device the same. The control unit may use a column and row driving scheme which is well known from prior art and widely used for active electronic displays like LCD, OLED etc.

The invention has mainly been described above with reference to a few embodiments. However, as is readily appreciated by a person skilled in the art, other embodiments than the ones disclosed above are equally possible within the scope of the invention, as defined by the appended patent claims.

1. A lighting system comprising:
a light guide,
at least one light source arranged for coupling light into the light guide,
wherein the light guide is configured such that a first portion of the light is emitted therefrom in a first direction, and a second portion of the light is emitted therefrom in a second general direction different to the first direction, and wherein the first portion of the light is substantially collimated and the second portion of the light is substantially divergent.

2. The lighting system according to claim 1, wherein said light source is a solid state light source.

3-4. (canceled)

5. The lighting system according to claim 1, comprising a plurality of light sources arranged in a substantially planar array at the light guide.

6. A lighting system according to claim 5, wherein at least one light sources of said plurality of light sources comprises a collimator.

7. A lighting system according to claim 1, further comprising control unit for individually controlling the at least one of the light sources.

8. A lighting system according to claim 5, wherein at least one section of the light source array comprises an incoupling facet for coupling light into the light guide and a first outcoupling facet for coupling light out of the light guide in the first direction.

9. A lighting system according to claim 8, wherein the section of the light source array further comprises a second outcoupling facet for coupling light out of the light guide in the second general direction.

10. A lighting system according to claim 9, wherein the second outcoupling facet is adjacent to the first outcoupling facet.

11. A lighting system according to claim 9, wherein any of the first and the second outcoupling facets is reflective and tilted in relation to of the light guide.

12. A lighting system according to claim 9, wherein the second outcoupling facet is curved.

13. A lighting system according to claim 9, wherein the first outcoupling facet and the second outcoupling facet together form a v-shape.

14. (canceled)

15. A lighting system according to claim 9, wherein the at least one light source of said plurality of light sources comprises a collimator and wherein the collimator includes the second outcoupling facet.

16. A lighting system according to claim 8, wherein each first outcoupling facet is opposite to a corresponding incoupling facet.

17. The lighting system according claim 1, wherein said light guide is a light guide plate.

18. The lighting system according to claim 1, wherein said second direction is generally opposite to the first direction.

19-21. (canceled)
